(19) United States
(12) Patent Application Publication
(10) Pub. No.: US 2010/0214096 A1
(43) Pub. Date: Aug. 26, 2010

(54) Vehicle Power Adapter With Locator System

(75) Inventor: Wei Cheng CHENG, Tucheng City (TW)

Correspondence Address: SCHMEISER OLSEN & WATTS, 18 E UNIVERSITY DRIVE, SUITE # 101, MESA, AZ, 85201, US

(73) Assignee: Lucent Trans Inc., Chino Hills, CA (US)

(21) Appl. No.: 12/390,825

(22) Filed: Feb. 23, 2009

(51) Int. Cl. G08B 1/08

(52) U.S. Cl. 340/539.32

(57) ABSTRACT

A vehicle power adapter with locator system which integrates RF transmitter with power adapter and uses power adapter to provide power to the locator system includes a power adapter transmitter and an external receiver. By integrating RF transmitter with vehicle power adapter (VPA), power can be drawn from vehicle power sockets to provide power to RF transmitter to send personal identification number (PIN) code to the RF receiver. The RF receiver which takes in the RF signals and PIN code from the transmitter to locate and display the position of the car by display the information on the liquid crystal display (LCD). Furthermore, the locator may remain dormant until it senses the trigger event or until a user requests the location of the parked vehicle.

### BACKGROUND OF THE INVENTION

1. Field of the Invention

This invention relates generally to power adaptor for a portable electronic device. The power adapter is mechanically structured so as to fit in the cigarette lighter socket of a vehicle, and more specifically it is a cigarette lighter adaptor having vehicle locator system to allow the driver to find where he parked the vehicle.

2. Description of the Prior Art

From time to time, most people have had an unpleasant experience of forgetting where they parked their vehicles. Searching for a parked automobile, whether in a large parking lot or in a parking garage, is a commonplace daily event in large U.S. cities and suburban areas. Searchers often may wander about for some time until they spot the vehicle. This practice is usually frustrating, and depending on the time of day and the location, may even be dangerous. Therefore, most people try to come up with some way of remembering and identifying exactly where an automobile was parked. Further, many of the automobiles and SUV's in today's parking lots look alike, which increases the difficulties of a straight forward sighting.

There have been attempts to offer products designed to assist users in locating vehicle. Some systems require the user to send wireless signal to a locator device that responds in turn with a visual or aural indicator. However, such manual systems have proven to be unreliable and prone to failed.

There are other issues with respect to the perceptibility of visual or aural response indications. For example, when a vehicle with a receiver/locator is hidden behind an object so that any visual indicator is hidden and aural indications are muffled, the user may not be able to perceive that responsive indicator. Or, if the vehicle is in another part of parking lot such that its responsive indicators are not perceivable, the user may give up their search, or continue to search in vain, without knowledge that the lost object is located nearby. Moreover, the receiver requires constant power supply and need to integrate into car electrical system. And not all drivers can install such a system by themselves. Thus, there is a need in the art for an apparatus with the system for locating vehicles. The apparatus eliminates the requirement of a dedicated transmitting device and overcomes the limitations associated with visual and aural indicators. The device is of such diminutive size and so low cost that it can be used in the vehicle without taking up spaces and costing extra money to install.

### SUMMARY OF THE INVENTION

It is present invention to provide a vehicle power adapter with locator system which integrates RF transmitter with power adapter and uses power adapter to provide power to the locator system.

Many modern vehicles are equipped with cigarette lighters. The lighter usually comprises a circular socket aperture with a removable lighter cap. The lighter socket can also be used to power a wide range of portable equipments. Recently, the sockets on their own (without the cigarette lighter cap) have been provided in cars. Sockets without cigarette lighter caps are often labeled simply as “vehicle power” sockets. To operate the communication device inside a vehicle, power adapters are commonly designed to fit into the cigarette lighter socket provided in the vehicle. The other end of the power adapter plugs into an external power input connector of the device.

By integrating RF transmitter with vehicle power adapter (VPA), power can be drawn from vehicle power sockets to provide power to RF transmitter to send personal identification number (PIN) code to the RF receiver. Other communication device can also be charged at same time by connecting power connector of the VPA.

It is another object of the present invention to provide a RF receiver which takes in the RF signals and PIN code from the transmitter to locate and display the position of the car by display the information on the liquid crystal display (LCD).

To achieve the above object, the present invention provides a) a power adapter transmitter which uses a transmitting embedded system to control radio frequency (RF) transmitter for transmitting RF signal to an external receiver and uses a receiving embedded system to calculate the position of the vehicle. This invention may be embodied in the form illustrated in the accompanying drawings, attention being called to the fact, however, that the drawings are illustrative only and changes may be made in the specific construction illustrated and described within the scope of the appended claims.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of vehicle power adapter with locator system which includes a power adapter transmitter and an external receiver;

FIG. 2 is a perspective view from inside of the vehicle with power adapter transmitter installed in vehicle power sockets;

FIG. 2a is a block diagram illustrating the components of the power adapter transmitter 1 for charging external device and transmitting RF signal along with PIN code;

FIG. 2b is a programming flow diagram illustrating the programming of said transmitting embedded system;

FIG. 3 is a perspective view from driver's view point holding an external receiver;

FIG. 3a is block diagram illustrating the components of the external receiver;

FIG. 3b is a programming flow diagram illustrating the programming of receiving embedded system;

### DETAILED DESCRIPTION OF THE PREFERRED EMBODIMENT

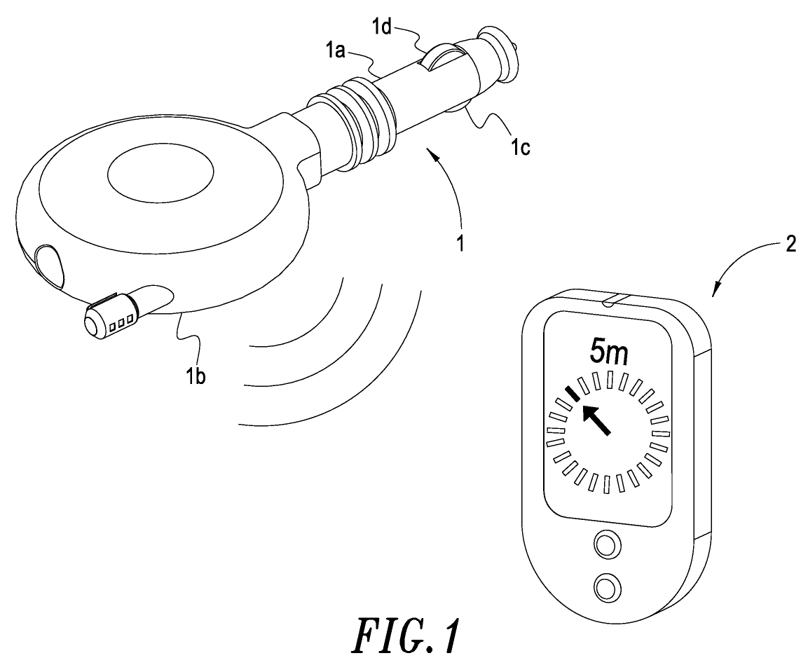

A vehicle power adapter with locator system is illustrated in FIG. 1 sending radio frequency (RF) signal and personal identification number (PIN) from a power adapter transmitter 1 to external receiver 2. The power adapter transmitter 1 comprises a handle 1b and a dongle 1a. The handle 1b and dongle 1a are preferably constructed from a rigid plastic material, like ABS, polycarbonate, or equivalent, and are preferably manufactured by a way of an injection molding process. The dongle 1a preferably comprises at least a first 1c and second 1d electrical contacts for coupling to corresponding electrical contacts in an automotive lighter socket.

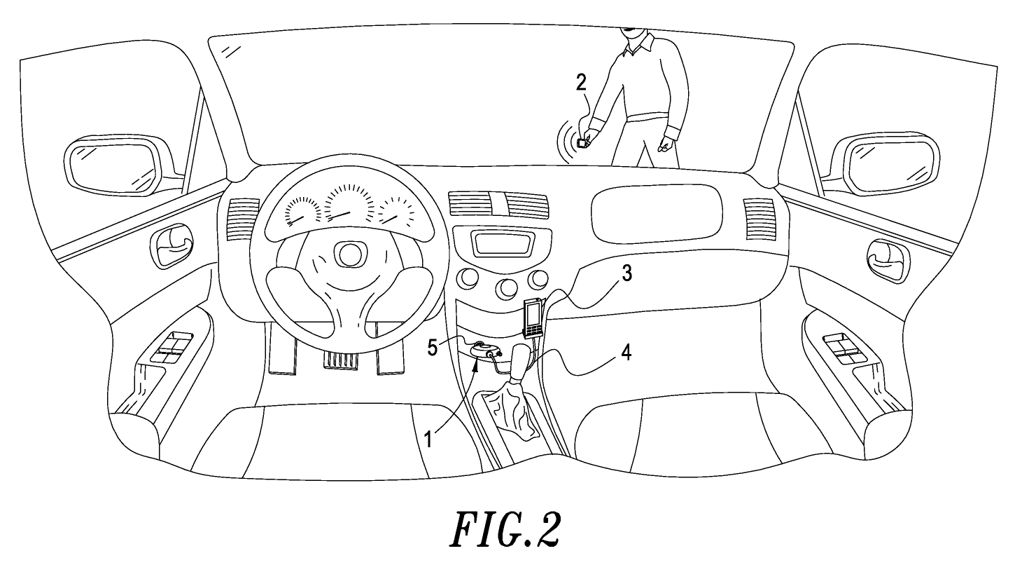

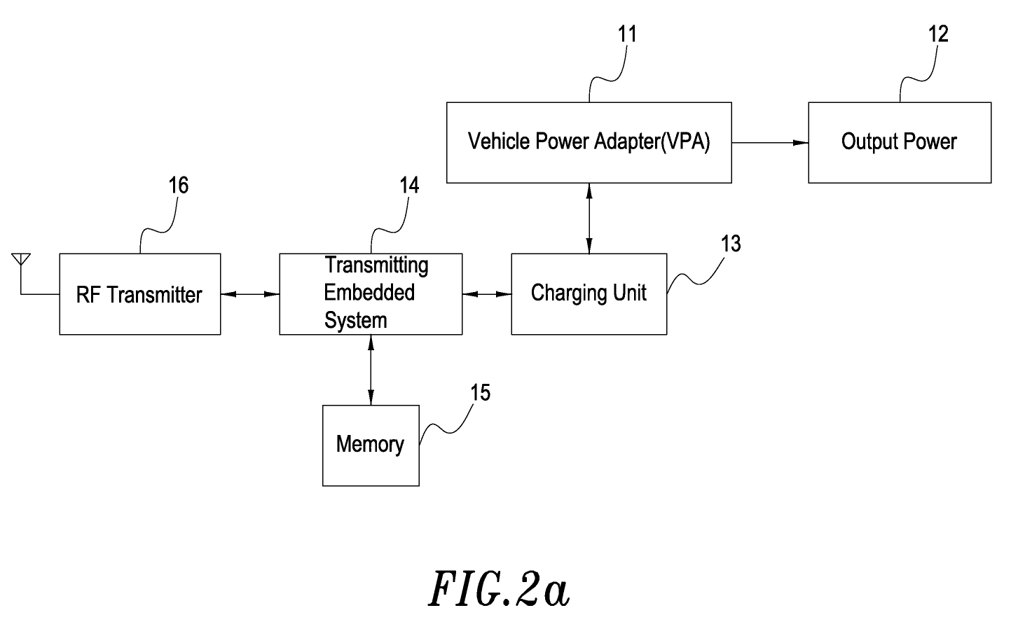

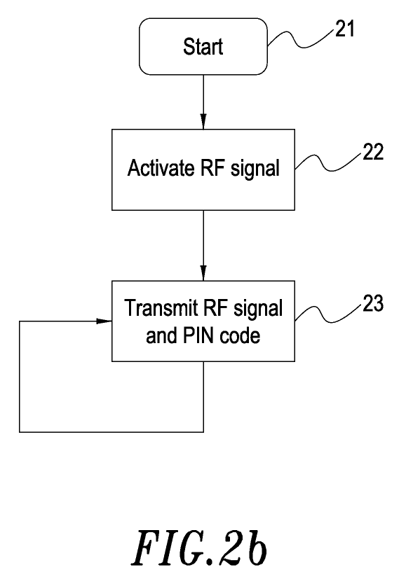

Thus, as shown in FIG. 2, power adapter transmitter 1 can be plugged into the lighter socket 5 in the vehicle to charge power adapter transmitter 1. External device 3 such as cell phones, iPod, and PDA or GPS system can be connected to the power adapter transmitter 1 as well by connecting output power module of power adapter transmitter 1 to external device 3 through connection cable 4. Charged power adapter transmitter 1 can send radio frequency (RF) signal and personal identification number (PIN) to said external receiver 2 which in turn is held by the drivers who is searching for right vehicle. A personal identification number (PIN) is a secret numeric password shared between the power adapter transmitter 1 and external receiver 2 that can be used to authenticate power adapter transmitter 1 to external receiver 2. Typically, the external receiver 2 is required to provide a non-confidential user identifier or token and a confidential PIN to gain access to the information that is transmitted by power adapter transmitter 1. Upon receiving the User ID and PIN, the system looks up the PIN based upon the User ID and compares the looked-up PIN with the received PIN. The external receiver 2 is granted access only when the number entered matches with the number stored in the power adapter transmitter 1

A block diagram illustrating the components of the power adapter transmitter 1 for charging external device and transmitting RF signal along with PIN code is provided in FIG. 2a. As shown in FIG. 2a, the power adapter transmitter 1 includes a vehicle power adapter 11 connecting with an output power module 12 and a charging unit 13 for providing power to external device and charging unit 13. Cables can be used to connect said output power module 12 to external device such as cell phones, iPod, PDA or GPS for power charging. The charging unit 13 furthermore connected to a transmitting embedded system 14. Power can be transferred from vehicle power adapter 11 to said transmitting embedded system 14. Also connected to the transmitting embedded system 14 are a radio frequency (RF) transmitter 16 for transmitting RF signal and a memory module 15. A transmitter of radio-frequency (RF) signals for wireless communication over some distance, which can vary from the short ranges within a building to long distances. The said radio frequency (RF) transmitter can utilize signals from very low frequencies (VLF) to extremely high frequencies (EHF). The radio-frequency output power varies from a fraction of a watt for short range distance and several megawatts in long-range, low-frequency transmitting. The transmitting embedded system 14 is utilized to control said radio frequency (RF) transmitter 16. The transmitting embedded system 14 is some combination of computer hardware and software, either fixed in capability or programmable, that is specifically designed for controlling the power adapter transmitter 1.

A programming flow diagram illustrating the programming of said transmitting embedded system is provided in FIG. 2b. As shown in this figure, the transmitting embedded system activates said radio frequency (RF) transmitter 22. Information and PIN which is stored in said memory module is encoded by said transmitting embedded system. The radio frequency (RF) transmitter transmit encoded information and PIN by radio frequency carrier wave and ready to be decoded by corresponding external receiver which is held by the driver 23.

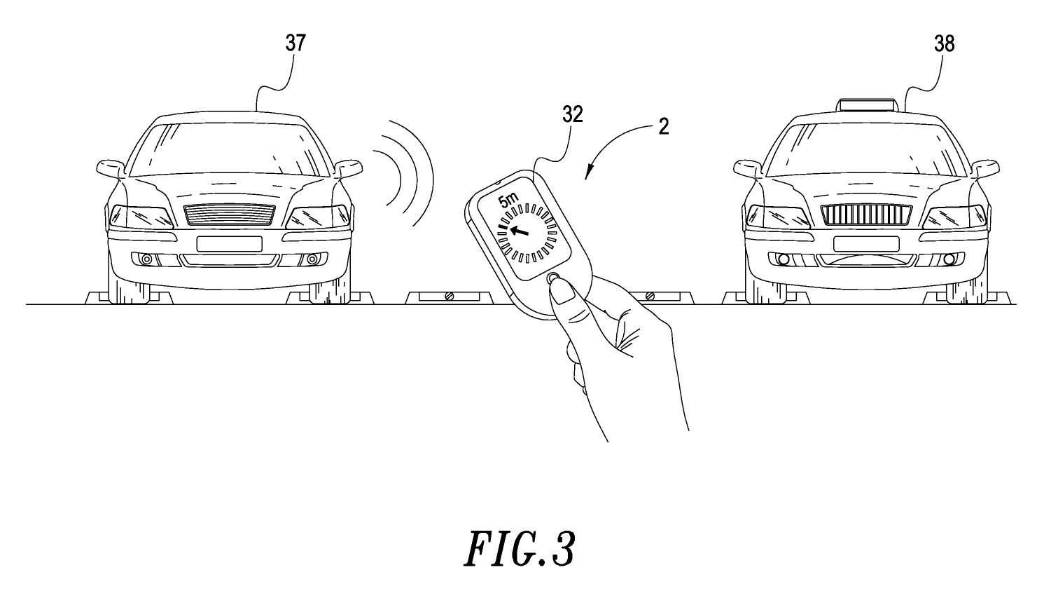

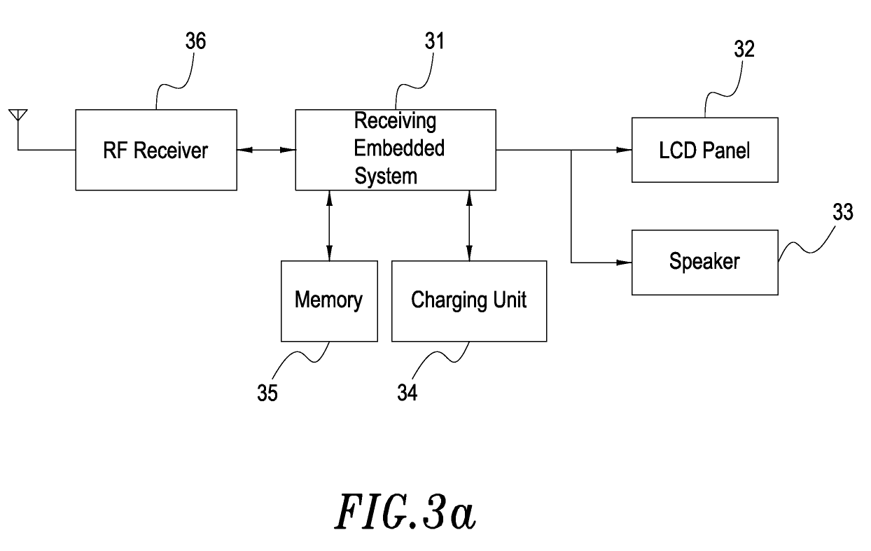

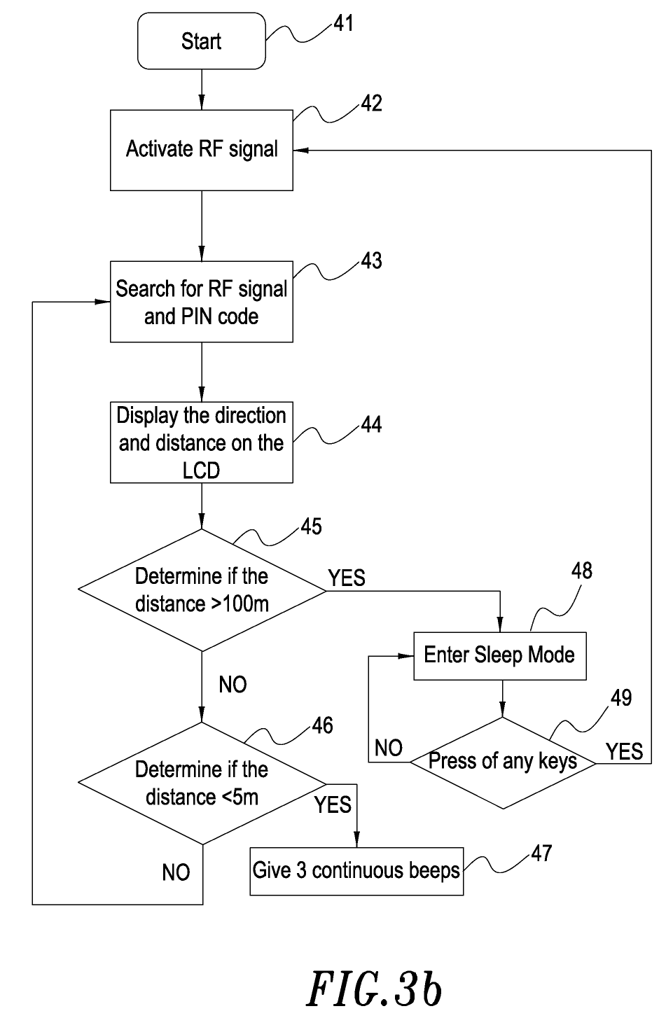

A perspective view from driver's view point is shown in FIG. 3. This view shows the driver trying to find where the vehicle 37 is among all the other vehicles 38 in the parking lot. The driver is holding said external receiver 2 which receiving encoded information and PIN from the power adapter transmitter inside the vehicle 37 via radio frequency (RF) wave. The external receiver 2 includes liquid crystal display 32 showing the direction and distance of the vehicle related to the driver.

A block diagram illustrating the components of the external receiver is provided in FIG. 3a. It is noted from the figure, the external receiver includes a receiving embedded system 31 for controlling operation of the external receiver. The receiving embedded system 31 is connected to said LCD panel 32 and speaker 33 to display or alarm distance and direction of the driver's vehicle. Also connected to the receiving embedded system 31 are the charging unit 34, memory module 35 and radio frequency (RF) receiver 36. The charging unit 34 provides power to the receiving embedded system 31. The memory module 35 stores the corresponding user ID and compares the looked-up PIN for identifying the corrected signal from said power adapter transmitter. The radio frequency (RF) receiver takes in the Radio frequency (RF) signal and PIN code from the power adapter transmitter in to locate the position of the vehicle by following four techniques.

Time of Arrival (TOA)
Time of arrival, TOA is method for determining the distance relative to the power adapter transmitter and the external receiver. The radio frequency (RF) receiver gain patterns of a rotating antenna or measurement of the very small time difference between the arrival of a radio frequency wavefront from the transmitter at one antenna and its arrival at another antenna.

Time Difference of Arrival (TDOA)
With the time difference technique (generally referred to as phase interferometry) the two antennas are held at the observing location a fixed distance from each other. The bearing angle of the radio wavefront relative to the two antennas is related to the measured difference in time of arrival by an inverse sine function. The relative phase difference between two electrical signals developed by the radio wavefront in the two antennas is determined through measurement.

Angle of Arrival (AOA)
Angle of Arrival measurement, or AOA, is a method for determining the direction of propagation of a radio-frequency wave incident on an antenna array. AoA determines the direction by measuring the Time Difference of Arrival (TDOA) at individual elements of the array—from these delays the AoA can be calculated. Its basic function is to measure the frequency of pulsed signals radiated from radio frequency (RF) transmitter. Generally, it may be said that radio frequency (RF) receiver measures the frequencies of incoming RF signals utilizing interferometric techniques by detecting the phase shift magnitudes produced in multiple, calibrated delay lines. For instance, the received RF signal is divided and simultaneously introduced into a non-delayed path and a delay line of known length. Since the delayed and non-delayed receiver paths are functions of the input signal frequency, conversion of the phase difference signals to video signals provides signals whose amplitudes are related to phase delay. These signals typically take the form of sin function which makes amplitude comparisons of the signals, determines the numerical value of .omega., and generates the digital frequency descriptive word.

By using the above techniques, the receiving embedded system is able to calculate and display distance and direction information on the LCD based on the RF signal sent from the power adapter transmitter.

A programming flow diagram illustrating the programming of said receiving embedded system is provided in FIG. 3b. At the step 42, the receiving embedded system activates the radio frequency (RF) receiver 42 and at step 44 said receiving embedded system search for RF signal and PIN code that is match the one stored in memory module. After finding the corresponding RF signal and PIN code, the receiving embedded system will display distance and direction information on the LCD. The receiving embedded system gives a beep with its speaker when it detects the signals fro the transmitter. At step 46, as the distance of the vehicle gets closer then 5 meters, the receiving embedded system will command speaker to give 3 continuous beeps at step 47. When the transmitter is 100 meters away, the receiving embedded system automatically enters sleep mode to save power and extend the life of the battery at step 45 and 48. At step 49 the receiver can be re-activated by hitting any of the function keys that is installed on the receiving embedded system.

In the above detailed description, reference is made to the accompanying drawings which form a part hereof and in which is shown by way of illustration specific embodiments in which the invention can be practiced. These embodiments are described in sufficient detail to enable those skilled in the art to practice and use the invention, and it is to be understood that other embodiments may be utilized and that electrical, logical, or structural changes may be made without departing from the spirit and scope of the present invention. The following detailed description is, therefore, not to be taken in a limiting sense and the scope of the present invention is defined by the appended claims and their equivalents.

What is claimed is:

1. A vehicle power adapter with locator system, comprising:
a power adapter transmitter including:
an output power module for providing power to external device;
a charging unit;
a vehicle power adapter connecting with said output power module and said charging unit for providing power to output power module and charging unit;
a radio frequency (RF) transmitter for transmitting RF signal;
a memory module;
a transmitting embedded system connecting with said charging unit, said memory module and said radio frequency (RF) transmitter; and
an external receiver including:
a liquid crystal display (LCD) panel for displaying position information of the car;
a charging unit;
a radio frequency (RF) receiver for receiving RF signal;
a memory module;
a receiving embedded system connecting with said charging unit, said memory module, liquid crystal display (LCD) panel and said radio frequency (RF) receiver.

2. The vehicle power adapter with locator system of claim 1 wherein said external receiver include a speaker which connected to said receiving embedded system.

3. The vehicle power adapter with locator system of claim 1 wherein said receiver embedded system calculated angle of arrival of the RF signal to find the location of the vehicle.

4. The vehicle power adapter with locator system of claim 1 wherein said receiver embedded system calculated time of arrival of the RF signal to find the location of the vehicle.

5. The vehicle power adapter with locator system of claim 1 wherein said receiver embedded system calculated time difference of arrival of the RF signal to find the location of the vehicle.

6. The vehicle power adapter with locator system of claim 1 wherein said receiving embedded system calculated received signal strength of the RF signal to find the location of the vehicle.

7. The vehicle power adapter with locator system of claim 1 wherein said transmitting embedded system encodes a personal identification number (PIN) code to transmit Radio Frequency (RF) signal though Radio Frequency (RF) transmitter.

8. The vehicle power adapter with locator system of claim 1 wherein said receiving embedded system has function keys to re-activate the receiving embedded system from sleeping mode.
